(19) United States
(12) Patent Application Publication
(10) Pub. No.: US 2002/0130909 A1
(43) Pub. Date: Sep. 19, 2002

(54) Inkjet printing system with internal drum paper feed

(75) Inventors: Timothy J. Wojcik, Rochester, NY (US); James E. Pickering, Bloomfield, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 09/811,703

(22) Filed: Mar. 19, 2001

(51) Int. Cl. B41J 3/00

(52) U.S. Cl. 347/2

(57) ABSTRACT

For an inkjet printer system having an internal paper supply roll (32) and a printhead carriage (38) for printing images on paper (18) from the paper supply roll (32), a paper handling system (24) for producing variable sized printed paper (18) is disclosed. The paper handling system (24) comprises a rotary drum (26) having a tube-shaped outer surface (30) with a plurality of cutter notches (50) predisposed at predetermined locations. The paper handling system (24) further comprises a paper feeder (48), a lead edge clamp (44) and a retractable cutting blade (42). Utilizing motorized means, the rotary drum (26) is first caused to rotate the paper (18) to a printing position. At the completion of printing, the rotary drum (26) is then caused to rotate the paper (18) to a cutting position. The paper (18) is then cut by the retractable cutting blade (42) with respect to the image area and the length of paper (18) desired, which is variable

### FIELD OF THE INVENTION

This invention relates in general to inkjet printing systems and, more specifically, to photographic image printing. More particularly, the invention relates to drum-based inkjet printing systems which accommodate flexible media format needs.

### BACKGROUND OF THE INVENTION

Without limiting the scope of the invention, its background is described in connection with inkjet printing systems, as an example.

Inkjet printing systems are commonly used for the production of text and graphic images for home, office and commercial applications. A number of system architectures have been developed in which the inkjet printhead is translated across the receiver media as it is held on a flat platen or drum. The receiver can be supplied either from a stack or several stacks of pre-cut receiver media, or can be cut from a receiver media supply roll and transported to the imaging platen or drum surface.

Drum-based printing systems and the associated receiver transport mechanisms for positioning and holding the cut receiver media onto the drum are described in U.S. Pat. No. 5,771,054; U.S. Pat. No. 5,445,604; U.S. Pat. No. 6,048,060 and EP 0 894 638 A1. Described therein, for example, are combinations of vacuum, electrostatics and mechanical clamping means for holding the cut receiver media onto the drum. Similarly, U.S. Pat. No. 4,703,329 describes receiver media which is supplied on a roll from the inside of the drum and held in contact with the drum surface by tensioning the web over the drum surface through drive rollers which are attached to the drum assembly. After printing, the desired length of receiver media is then fed off the drum to an external cutter.

There are, however, two main disadvantages associated with the internal drum paper feed concept described in U.S. Pat. No. 4,703,329. First, the ink on the printed media is typically wet after application, thus causing image quality artifacts due to ink transfer to the exit drive rollers. Second, a significant amount of receiver media is wasted on each printed segment due to the amount of media which is threaded in the exit drive system path and thus not accessible for printing.

Accordingly, a need exists for a system which does not require vacuum means to hold the receiver media onto the drum. Furthermore, a need exists for a system which would deliver printed receiver media segments to a post-print treatment station for drying without touching the image surface so as to not create image quality artifacts. A means of enabling cutting of receiver media with minimal waste, particularly at the trailing edge of the printed segment, would provide numerous advantages.

### SUMMARY OF THE INVENTION

The present invention provides a system and method of accommodating flexible media. With the present invention, the amount of waste with regard to receiver media, which is typically high in cost, is minimized.

Accordingly, disclosed in one embodiment is a receiver media handling system for producing variable sized printed receiver media for an inkjet printer having an internal receiver media supply roll and a printhead for printing images on the receiver media from the supply roll. The receiver media handling system comprises a drum having a tube-shaped outer surface with a plurality of cutter notches predisposed at predetermined locations. In one embodiment, the drum is a rotary drum configured to rotate counter-clockwise in order to position cut receiver media to exit along a receiver media exit path. Once the cut receiver media is unloaded, the rotary drum is configured to return to a receiver media feed position by way of rotation.

The receiver media handling system also comprises a receiver media feeder for drawing receiver media from the internal supply roll and along the outer surface of the drum. The receiver media handling system further comprises at least one in-feed drive roller and an outer guide shoe. The in-feed drive roller is configured to engage onto the tube-shaped outer surface of the drum, push the receiver media from the receiver media supply roll to a clamp, or lead edge clamp, and retract from the outer surface to allow for printing. The outer guide shoe is adapted to guide the receiver media from the supply roll to the lead edge clamp, which is incorporated onto the rotary drum for retaining an edge of the receiver media from the supply roll at a location about the drum.

The receiver media handling system further comprises means for retaining the receiver media from the internal receiver media supply roll in a printing position. In one embodiment, the receiver media from the internal supply roll is tensioned between the lead edge clamp and the receiver media supply roll. Tensioning is performed by motorized means which causes the drum to first rotate from the receiver media supply roll to a printing position, and then causes the drum to retract the receiver media to a cutting position following printing.

The receiver media handling system further comprises a stripper/in-feed guide configured to cause the cut receiver media to exit onto a post-print treatment station. The post-print treatment station can include a paper tray, a dryer section, or a laminator, for example.

According to an exemplary embodiment, disclosed is a printer system for producing variable sized printer receiver media. The printer system comprises a receiver media handling system for an inkjet printer having an internal receiver media supply roll; a printhead carriage for printing images within an image area on the receiver media from the supply roll; and a post-print treatment station adapted to receive the variable sized printed receiver media. The printhead carriage may be page-width and stationary so that printing occurs as the received medium is translated across the printhead surface. Alternatively, the printhead is non-page width requiring axial motion of the printhead about the rotary drum for printing to occur across the entire width of the receiver medium. In all aspects, the printhead and rotary drum are compatible with known writing modes, such as indexing and interleaving, utilized to achieve accurate and precise images on the receiver medium.

In accordance with yet another embodiment, disclosed is a method of accommodating flexible media format needs for an inkjet printer including a rotary drum having a tube-shaped outer surface with a plurality of cutter notches predisposed at predetermined locations, an internal receiver media supply roll, and means for printing images on the receiver media from the supply roll. The method comprises the step of drawing the lead edge of the receiver media from the supply roll and along the outer surface of the rotary drum. In operation, the rotary drum is rotated with at least one in-feed drive roller passively engaged to urge the receiver media onto the drum surface in order to tension the receiver media around the rotary drum through the receiver media supply roll. That is, the receiver media is driven around the rotary drum via an outer guide shoe and out to a lead edge clamp. A stripper/in-feed guide is then engaged to cause the leading edge of the receiver medium to be positioned for clamping by the lead edge clamp.

After clamping, the receiver media is then tensioned around the rotary drum through the receiver media supply roll. Once the receiver media has been tensioned, the receiver media about the outer surface is then positioned for printing. As such, an image area where printing is to be applied on the receiver media is defined, and the in-feed drive roller is retracted from the outer surface of the rotary drum to allow for printing within the defined image area. Concurrently, the rotary drum is activated to speed for printing. In a preferred embodiment, a is printhead carriage is then translated across the rotary drum for printing images on the receiver media within the defined image area. That is, one image can be printed onto the receiver media and can be of any of the prescribed lengths where the cutting notches are positioned. Thus, printing can occur from the lead edge of the receiver media up to the six o'clock position; from the lead edge to the three o'clock position; or from the lead edge to the twelve o'clock position, for example.

The method further comprises the step of cutting the receiver media at any one of the cutter notches predisposed at predetermined locations about the outer surface of the rotary drum. Once printing is complete, the rotary drum is deactivated, and thus rotated to a desired cutting position with respect to the predisposed cutting notches. The method also comprises the step of causing a retractable cutting blade, or rotary cutter wheel, to come in contact with the receiver media on the rotary drum by running against the cutter notches on the outer surface. Once the receiver media has been cut at the desired length, the cutting blade is retracted and the rotary drum is rotated in the counter-clockwise direction. As such, the cut receiver media is pushed out of its original path and onto the path of the stripper/in-feed guide.

The method also comprises the step of causing the cut receiver media to exit a receiver media path via the stripper/in-feed guide. That is, the cut receiver media is unloaded to a post-print treatment station, such as a paper tray, a dry section or a laminator. The rotary drum is then rotated and returned to a paper feed position for the next printing cycle.

Technical advantages of the present invention include a smaller-sized printer system since the rotary drum assembly comprises an internal receiver media supply roll.

Other technical advantages include delivery of wet, printed receiver media to a post-print treatment station for drying without touching the image surface. In addition, the position of the image on the receiver media is precisely known while it is being held on the rotary drum, thus enabling cutting with minimal waste, particularly at the trailing edge of the printed segment. Furthermore, the present invention includes a system which does not require vacuum means to hold the receiver media onto the drum.

### BRIEF DESCRIPTION OF THE DRAWINGS

For a more complete understanding of the present invention, including its features and advantages, reference is made to the following detailed description of the invention, taken in conjunction with the accompanying drawings in which:

FIG. 1 is a diagram illustrating the drum assembly of a prior art inkjet printer system;

FIG. 2 is a perspective view of a rotary drum incorporated in an inkjet printer, according to one embodiment of the present invention;

FIGS. 3A-3C illustrate the paper feed position along with the method of drawing paper from the paper supply roll and along the outer surface of the rotary drum, in accordance with a preferred embodiment of the present invention; and

FIGS. 4A-4B illustrate the paper exit position along with the steps of cutting the paper at any one of the cutter notches and causing the cut paper to exit a paper exit path, in accordance with a preferred embodiment of the present invention.

Corresponding numerals and symbols in these figures refer to corresponding parts in the detailed description, unless otherwise indicated.

### DETAILED DESCRIPTION OF THE INVENTION

While the making and using of various embodiments of the present invention are discussed in detail below, it should be appreciated that the present invention provides many applicable, inventive concepts which can be embodied in a wide variety of specific contexts. These specific embodiments discussed herein are merely illustrative of specific ways to make and use the invention, and do not delimit the scope or application of the invention.

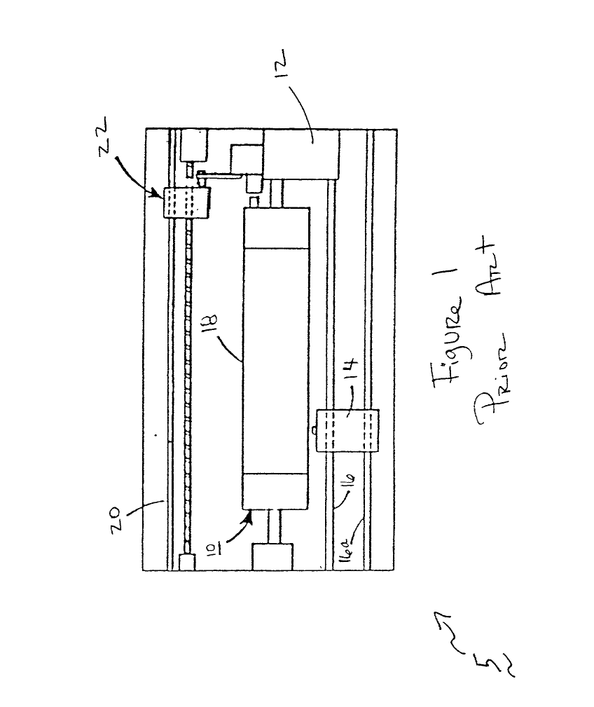

Referring to FIG. 1, therein is shown an inkjet printer that includes a rotatable drum 10 driven by a stepping motor 12. An inkjet printhead assembly 14 is mounted for longitudinal movement along tracks 16 and 16a. The imaging paper, or other sheet material 18, envelopes the outer surface of the rotatable drum 10 during the imaging process and, at its conclusion, is ejected across a cutter bar 20 where it is sheered by a cutter mechanism, generally indicated at 22. The term “sheet material” as used in this application includes the various flexible materials on which images can be recorded, such as paper, transparencies and photographic materials, which are supplied in long length. All such flexible material will be referred to hereinafter as paper 18. While the rotatable drum 10 rotates, the inkjet printhead assembly 14 moves longitudinally along the rotatable drum 10 following a writing path on the paper 18 to produce the desired image. As the completed image is ejected, a length of unused paper 18 is simultaneously drawn from the interior of the rotatable drum 10 and positioned around the outside of the rotatable drum 10.

There are two main disadvantages which exist in the prior art printer system, such as those represented by FIG. 1. First, excessive waste of the receiver media, or paper 18 results in an efficient printer. Second, ink artifacts tend to appear on the drive rollers due to wet ink. In operation, the prior art printer systems, such as printer system 5, provides for ink to be laid out onto the paper 18, forming an image. The paper 18, which is still wet from the ink application, is then driven through a drive roller set (not shown) in order to meter out the paper 18 or determine where the paper 18 is to be cut. As such, ink is transferred onto the drive rollers, causing ink artifacts.

Furthermore, the prior art printer systems rely on the lead edge of the paper 18 to be fed out through the drive rollers. As a result, the amount of paper 18 that is contained within the rollers is wasted when the image paper segment is “topped off” or cut, thus causing excessive waste of the receiver media. If the printer system is utilized for photographic or other high-end applications, the waste of receiver medium (e.g. high quality gloss, matte, or large paper format) can be quite expensive.

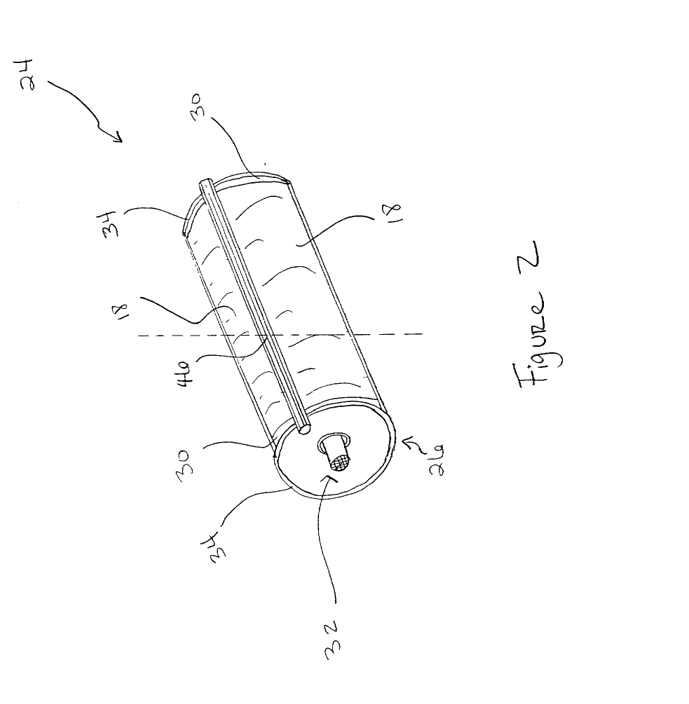

FIG. 2 illustrates a paper handling system, denoted generally as 24, in accordance with one embodiment of the present invention. Receiver media, or paper 18, is supplied from a paper supply roll 32 contained within the rotary drum 26. Due to the rotary drum 26 having an internal paper supply roll 32, the paper handling system 24, as well as the printer system embodying paper handling system 24, is smaller in size. The term “receiver media” as used herein includes the various flexible media on which images can be recorded, such as paper, transparencies and photographic paper, which are supplied as a roll in long length. The term “paper” will be used hereinafter when referring to the various types of flexible media.

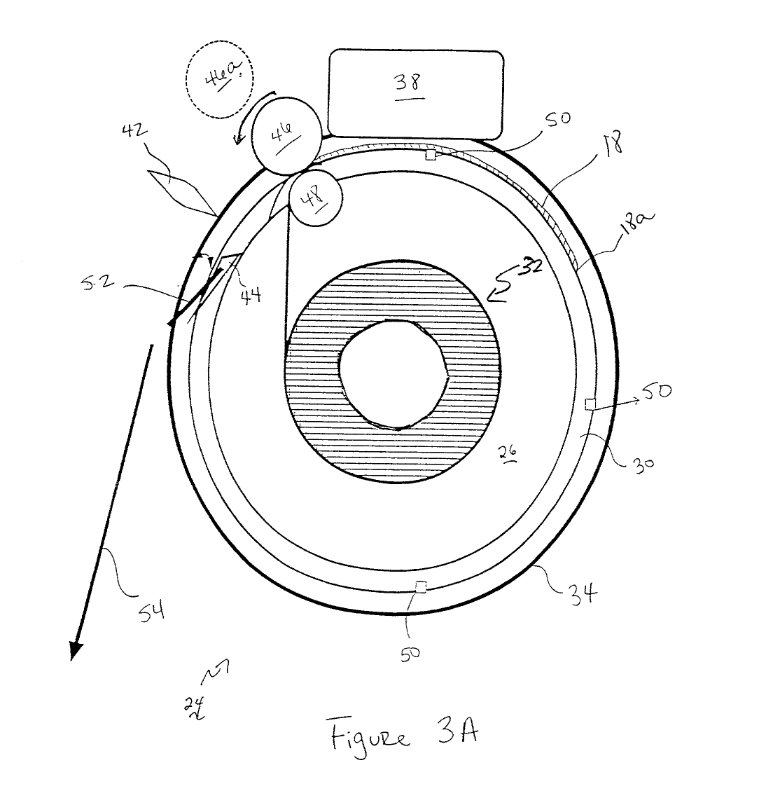

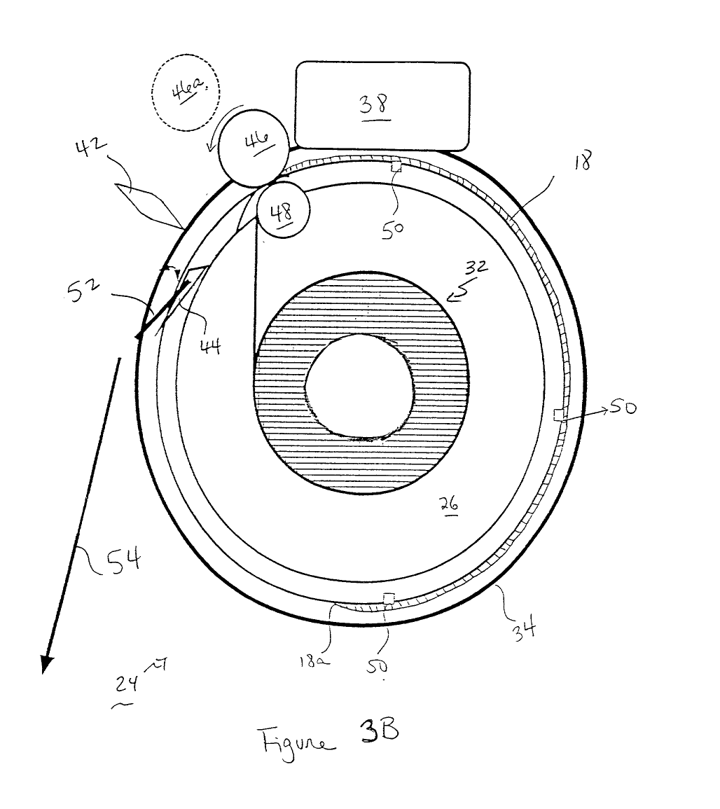

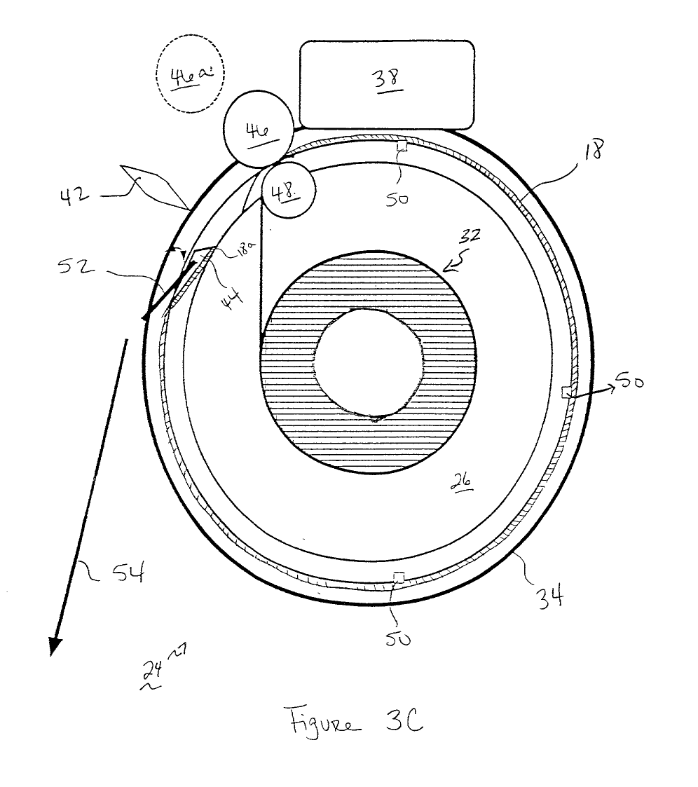

In a solution, paper 18 is fed onto the outer surface 30 of the rotary drum 26 and held in place by tensioning the paper 18 between a lead edge clamp 44 (discussed below in FIGS. 3A-3C) and the paper supply roll 32. The amount of paper 18 on the outer surface 30 of the rotary drum 26 is constant for all requested print formats, but the image area for the current printjob determines the length of the finished segment of paper 18.

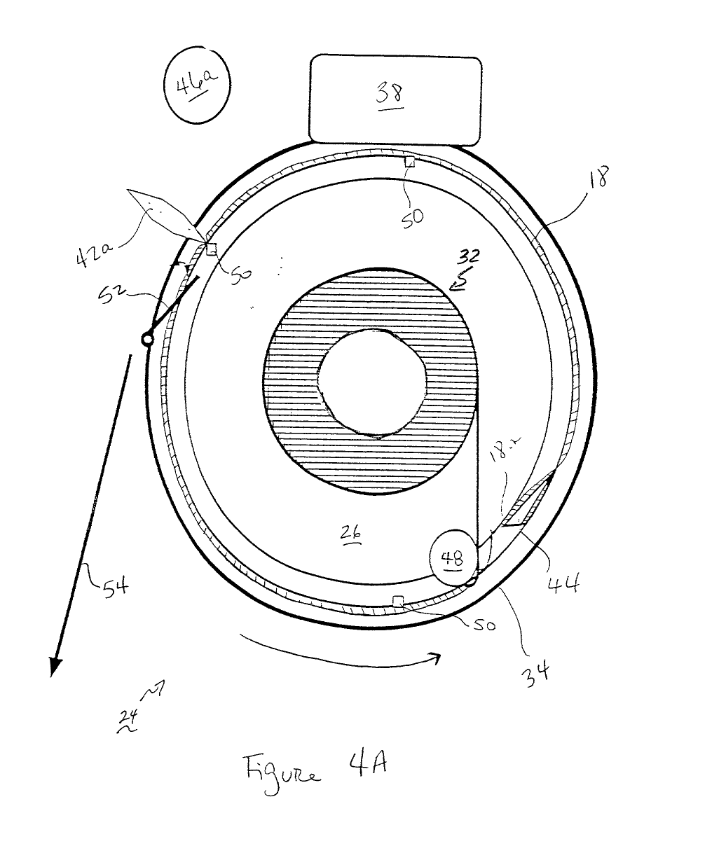

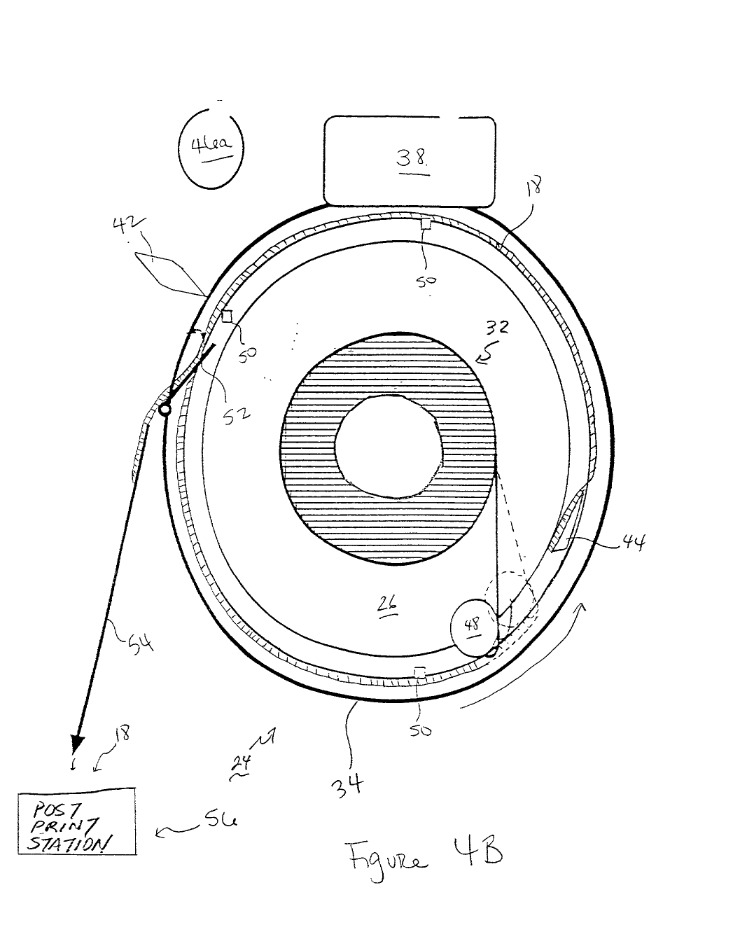

With reference to FIGS. 3A-3C and 4A-4B, therein is shown a cross-section of the paper handling system 24 of FIG. 2 and its operation. Specifically, FIGS. 3A-3C illustrate the steps associated with the paper feed position, while FIGS. 4A-4B illustrate the steps associated with the paper exit position. Those skilled in the art will appreciate that the figures referred to herein are not drawn to scale and have been enlarged in order to illustrate the major aspects of the present invention. A scaled drawing would not show the fine detail necessary to portray and understand the present invention.

In one embodiment, a printer system for producing variable size printed paper 18 comprises a paper handling system 24 having an internal paper supply roll 32; a printhead carriage 38 for printing images within an image area on the paper 18 of the supply roll 32; and a post-print treatment station 56 (shown in FIG. 4B) adapted to receive the variable size printed paper 18 following printing and sizing/cutting.

With reference to FIGS. 3A-3C, therein is shown a cross-section of paper handling system 24 comprising a rotary drum 26 having a tube-shaped outer surface 30 with a plurality of cutter notches 50 predisposed at predetermined locations along surface 30. A paper feeder 48 is configured to draw paper 18 from the paper supply roll 32 and along the outer surface 30, as shown in FIG. 3A. A motor (not shown) provides the driver power for the paper feeder as is well known to those of ordinary skill in the art. In one embodiment, the paper handling system 24 comprises at least one in-feed drive roller 46, which initially is in the retractable position 46a. As such, the in-feed drive roller 46 is configured to engage onto the outer surface 30 and to push the paper 18 from the paper supply roll 32 to a lead edge clamp 44, as illustrated in FIGS. 3B and 3C. That is, the paper 18 is driven around the rotary drum 26 and out to the lead edge clamp 44. The paper handling system 24 can comprise additional in-feed drive rollers predisposed around the rotary drum 26, if necessary.

In operation, the outer guide shoe 34 is adapted to guide the paper 18 from the paper supply roll 32 toward the lead edge clamp 44, which is incorporated onto the rotary drum 26. Upon reaching its desired location, the lead edge 18a of the paper 18 from the supply roll 32 is retained by the lead edge clamp 44 at that particular location about the rotary drum 26. That is, the stripper/in-feed guide 52 is configured to urge the lead edge clamp 44 to engage in a clamped position, as shown in FIG. 3C.

Once the lead edge 18a of the paper 18 has been securely retained in place via the lead edge clamp 44, the paper 18 is tensioned around the rotary drum 26 through the paper supply roll 32. As such, the only wasted paper is the lead edge 18a of the paper 18 under the lead edge clamp 44, unlike the prior art printer systems, such as those represented by FIG. 1. Thus, paper waste is minimized.

The rotary drum 26 is then activated and positioned for printing. In one embodiment, the printhead carriage 38 is translated across the rotary drum 26 while printing images on the paper 18 within a defined image area. That is, printing can occur anywhere within the area of paper 18 positioned around the outer surface 30 of the rotary drum 26 between the paper supply roll 32 and the lead edge clamp 44. For example, one image can be printed on the paper 18 and can be any of the prescribed lengths where the cutter notches 50 are positioned. That is, in one embodiment, printing can occur from the lead edge clamp 44 to the three o'clock position; from the lead edge clamp 44 to the six o'clock position; or from the lead edge clamp 44 to the twelve o'clock position. Thus, in this particular embodiment, images can be printed at three different lengths. One skilled in the art can appreciate that any number of cutter notches 50 can be predisposed about the outer surface 30 of the rotary drum 26. Furthermore, the locations of the cutter notches 50 are then used to determine the desired area and length in which the image is to be printed, as well as the length of the paper 18 to be cut.

In yet another embodiment, the printhead carriage 38 is stationary and spans the entire width of the receiver medium (e.g. page-width). As such, printing of the desired image is accomplished by rotation of the rotary drum 26 with respect to the position of the printhead carriage 38. Once printing is complete, the rotary drum 26 is deactivated or brought to a stop. Alternatively, the printhead carriage may be less than page-width requiring axial translation of the printhead carriage 38 about the rotary drum 26 to accomplish full width printing on the receiver medium. In either case, the motion of the printhead carriage 38 may also involve a writing mode, such as indexing or interleaving, to correct for printing artifacts on the receiver medium. Such printing processes are well known in the art.

Utilizing the printed image area for the current printjob, the location as to where to cut the paper 18 with respect to length is determined. The rotary drum 26 is then rotated in the counter-clockwise direction, as shown in FIG. 4A, to the desired cutting position where a cutting blade 42, or rotary cutting wheel, is located and configured to cut the paper 18 at any one of the cutter notches 50. The cutting blade 42 is initially in a retracted position 42a during the paper feed process and printing, as shown in FIGS. 3A-3C. However, once the rotary drum 26 is in the cutting position, the cutting blade 42, or rotary cutting wheel, is then configured to come in contact with the paper 18 on the rotary drum 26 and cut the paper 18 to length by running against the cutter notches 50 on the outer surface 30.

The cutter blade 42 is then adapted to return to its retracted position 42a in order to allow the rotary drum 26 to rotate counter-clockwise. In doing so, the cut paper 18 is pushed out of its original path and onto the path of the stripper/in-feed guide 52 as shown in FIG. 4B. As such, the stripper/in-feed guide 52 is configured to cause the cut paper 18 to exit onto a post-print treatment station 56 (shown in FIG. 4B) such as a paper tray, a dryer section or a laminator, for example. The rotary drum 26 is then returned to the paper feed position via rotation in order to proceed with the next cycle of image printing.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is, therefore, intended that the impended claims encompass any such modifications or embodiments.

### PARTS LIST

10 . . . rotatable drum

12 . . . stepping motor

14 . . . inkjet printhead assembly

16 . . . track

16a . . . track

18 . . . paper, receiver media, or imaging paper

18a . . . lead edge

20 . . . cutter bar

22 . . . cutter mechanism

24 . . . paper handling system

26 . . . rotary drum

30 . . . outer surface

32 . . . paper supply roll or receiver media supply roll

34 . . . outer guide shoe

38 . . . printhead carriage

42 . . . cutting blade or rotary cutting wheel

42a . . . retracted position

44 . . . lead edge clamp, or clamp

46 . . . in-feed drive roller

46a . . . retractable in-feed drive roller

48 . . . paper feeder

50 . . . cutter notch(es)

52 . . . stripper/in-feed guide

54 . . . paper exit path

56 . . . post-print treatment station

What is claimed is:

1. A printer system for producing variable sized printed receiver media comprising:
a receiver media handling system for an inkjet printer having an internal receiver media supply roll;
a printhead carriage for printing images within an image area on said receiver media from the supply roll; and
a post-print treatment station adapted to receive said variable sized printed receiver media.

2. The printer system according to claim 1 wherein said receiver media handing system further comprises:
a rotary drum having a tube-shaped outer surface with a plurality of cutter notches predisposed at predetermined locations;
a receiver media feeder for drawing receiver media from said supply roll and along said outer surface;
a lead edge clamp incorporated onto said rotary drum for retaining an edge of receiver media from said supply roll at a location about said rotary drum;
a retractable cutting blade for cutting receiver media at any one of said cutter notches; and
motorized means for causing said rotary drum to first rotate receiver media from said supply roll to a printing position and retract said receiver media to a cutting position following printing.

3. The printer system according to claim 2 wherein said rotary drum is adapted to run counter-clockwise causing the cut receiver media to unload onto said post-print treatment station.

4. The printer system according to claim 2 further comprising at least one in-feed drive roller configured to engage onto said tube-shaped outer surface and push said receiver media from said receiver media supply roll to said lead edge clamp.

5. The printer system according to claim 4 wherein said in-feed drive roller is configured to retract for printing.

6. The printer system according to claim 2 further comprising a means for retaining said receiver media from the supply roll in a printing position by tensioning said receiver media from the supply roll between said lead edge clamp and said receiver media supply roll.

7. The printer system according to claim 2 further comprising a means for causing said rotary drum to return to a receiver media feed position to begin a new cycle.

8. The printer system according to claim 2 wherein the amounts of receiver media from said supply roll on said outer surface of said rotary drum is constant for all requested print formats.

9. The printer system according to claim 2 further comprising a means for determining the location to cut said receiver media utilizing the image area for the current print job.

10. The printer system according to claim 2 further comprising a stripper/in-feed guide configured to cause said cut receiver media to exit onto a post-print treatment station, such as a paper tray, a dryer section, or a laminator.

11. The printer system according to claim 2 further comprising an outer guide shoe adapted to guide said receiver media from the supply roll toward said lead edge clamp.

12. The printer system according to claim 1 wherein said printhead carriage is page-width.

13. The printer system according to claim 2 wherein said printhead carriage is configured to translate across said rotary drum.

14. For an inkjet printer system having an internal receiver media supply roll and a printhead for printing images on receiver media from the supply roll, a receiver media handling system for producing variable sized printed receiver media comprising:
a drum having a tube-shaped outer surface with a plurality of cutter notches predisposed at predetermined locations;
a receiver media feeder for drawing receiver media from said supply roll and along said outer surface;
a clamp for retaining an edge of receiver media from said supply roll at a location about said drum;
a cutting blade for cutting receiver media at any one of said cutter notches; and
motorized means for causing said drum to first rotate receiver media from said supply roll to a printing position and retract said receiver media to a cutting position following printing.

15. The receiver media handling system according to claim 14 wherein said drum is a rotary drum.

16. The receiver media handling system according to claim 15 further comprising means for causing said rotary drum to rotate counter-clockwise so as to position the cut receiver media to exit.

17. The receiver media handling system according to claim 15 further comprising a means for causing said rotary drum to return to a receiver media feed position upon unloading the cut receiver media through a designated exit.

18. The receiver media handling system according to claim 15 wherein said clamp is a lead edge clamp incorporated onto said rotary drum.

19. The receiver media handling system according to claim 18 further comprising means for retaining said receiver media from the supply roll in a printing position by tensioning said receiver media from the supply roll between said lead edge clamp and said receiver media supply roll.

20. The receiver media handling system according to claim 18 further comprising an outer guide shoe adapted to guide said receiver media from the supply roll to said lead edge clamp.

21. The receiver media handling system according to claim 17 further comprising at least one in-feed drive roller configured to engage onto said tube-shaped outer surface and push said receiver media from said receiver media supply roll to said lead edge clamp.

22. The receiver media handling system according to claim 21 wherein said in-feed drive roller is configured to retract for printing.

23. The receiver media handling system according to claim 14 wherein said cutting blade is a retractable cutting blade.

24. The receiver media handling system according to claim 14 wherein said cutting blade is a rotary cutter wheel.

25. The receiver media handling system according to claim 24 wherein said rotating cutter wheel is configured to retract from said drum.

26. The receiver media handling system according to claim 14 further comprising a stripper/in-feed guide configured to cause said cut receiver media to exit onto a post-print treatment station, such as a paper tray, a dryer section, or a laminator.

27. For an inkjet printer including a rotary drum having a tube-shaped outer surface with a plurality of cutter notches predisposed at predetermined locations, an internal receiver media supply roll, and means for printing images on said receiver media from the supply roll, a method of accommodating flexible media format needs comprising the steps of:
drawing said receiver media from said supply roll and along said outer surface;
retaining an edge of said receiver media from said supply roll at a location about said rotary drum;
cutting said receiver media at any one of said cutter notches; and
causing the cut receiver media to exit a receiver media path.

28. The method according to claim 27 wherein said drawing step further comprises the step of causing a retractable in-feed drive roller to come in contact with said outer surface.

29. The method according to claim 28 wherein said step of causing a retractable in-feed drive roller to come in contact with said outer surface further includes the step of driving said receiver media around said rotary drum and out to a lead edge clamp.

30. The method according to claim 29 wherein said driving step further includes the step of guiding said receiver media around the circumference of said rotary drum.

31. The method according to claim 27 wherein said retaining step further includes the step of defining an image area on said receiver media for printing.

32. The method according to claim 27 wherein said retaining step is followed by the step of tensioning said receiver media around said rotary drum through said receiver media supply roll.

33. The method according to claim 32 wherein said tensioning step is followed by the step of activating said drum to speed.

34. The method according to claim 33 wherein said activating step is followed by the step of translating a printhead carriage across said rotary drum for printing images on said receiver media within said image area.

35. The method according to claim 34 wherein said translating step further includes the step of causing said printhead carriage to print from said edge of said receiver media from the supply roll up to the six o'clock position.

36. The method according to claim 34 wherein said translating step further includes the step of causing said printhead carriage to print from said edge of said receiver media from the supply roll up to the three o'clock position.

37. The method according to claim 34 wherein said translating step further includes the step of causing said printhead carriage to print from said edge of said receiver media from the supply roll up to the twelve o'clock position.

38. The method according to claim 27 wherein said cutting step is preceded by the step of deactivating said rotary drum.

39. The method according to claim 38 wherein said deactivating step is followed by the step of rotating said rotary drum to a desired cutting position.

40. The method according to claim 39 wherein said rotating step is followed by the step of causing a retractable cutter blade to come in contact with said receiver media on said rotary drum by running against said cutter notches on said outer surface.

41. The method according to claim 27 wherein said cutting step is followed by the step of rotating said rotary drum counter-clockwise.

42. The method according to claim 41 wherein said step of rotating said rotary drum counter-clockwise further includes the step of pushing the cut receiver media out of its original path and onto the path of a stripper/in-feed guide.

43. The method according to claim 27 wherein said step of causing said cut receiver media to exit a receiver media path is followed by the step of causing said rotary drum to return to a paper feed position for the next cycle.
